(19) United States
(12) Patent Application Publication
(10) Pub. No.: US 2025/0077813 A1
(43) Pub. Date: Mar. 6, 2025

(54) USE OF QR CODE FOR ANONYMOUS IMAGE SHARING BETWEEN ATTENDEES OF THE SAME EVENT/EXPERIENCE

(71) Applicant: Mark Gilleo, Vienna, VA (US)

(72) Inventor: Mark Gilleo, Vienna, VA (US)

(21) Appl. No.: 18/528,871

(22) Filed: Dec. 5, 2023

Related U.S. Application Data
(60) Provisional application No. 63/387,292, filed on Dec. 14, 2022.

(51) Int. Cl. G06K 7/14; G06K 19/06

(52) U.S. Cl. CPC G06K 7/1417; G06K 19/06037

(57) ABSTRACT

The present invention is a system and method for the anonymous sharing of digital content (such as photos, images, and/or videos) between Attendees of the same Event/Experience using a unique identifier code. This code may be generated, at the request of an Event Host/Organizer, via an application that may be accessed on the web, or as a mobile App. This unique identifier code may be disseminated by the Host/Organizer via myriad means and then be scanned by Event/Experience Attendees using a smart phone, tablet, computer, smartwatch, or other device that has scanning capability and internet connectivity. Once the code has been scanned, Attendees may anonymously access a shared image gallery for that Event/Experience where they may anonymously upload, peruse, and download images.

### CROSS REFERENCE TO RELATED APPLICATIONS

U.S. Pat. No. 10,769,590B2 September 2020 Baldwin
US2014/0313352 October 2014 De Rosa
U.S. Pat. No. 10,885,307B2 January 2021 Jacobs
U.S. Pat. No. 10,841,114B2 November 2020 Svendsen
U.S. Pat. No. 9,178,920B2 November 2015 Tsukagoshi
WO2015/035055A1 March 2015 Marisco
US20180302502A1 October 2018 Teshima
U.S. Pat. No. 9,591,039B2 March 2017 O'Brien
U.S. Pat. No. 9,569,658 February 2017 Johnson
U.S. Ser. No. 14/486,272 September 2015 Prasanna

### BACKGROUND

In recent years, there has been a dramatic increase in the number of digital images, photographs, and videos being captured and shared. This proliferation has largely been enabled by smart phones with the ability to take high-quality photographs and videos. In addition to the ubiquitous nature of the camera-enabled smart phone, the impact of social media has multiplied the desire of individuals to share images with others.

Numerous attempts to bridge the gap between those who want to share images with those who may wish to see those images have been made. Yet, the ease of sharing images between individuals who may be unknown to each other, remains an impediment. Accounts, User IDs, phone numbers, emails, and company-specific handles are often needed to share images. In many cases it may be impractical, or even impossible, for individuals to engage with other individuals at the same Event/Experience to facilitate image sharing. Even when possible, individuals may be reluctant to share personal data with other unknown individuals. Individuals may also be reluctant to open a new account with yet another company to facilitate image sharing. This reluctance is even more poignant when the image sharing pertains to an Event/Experience that is fleeting in nature. Many individuals may consider account creation and/or sharing personal data a steep price to pay to acquire images from an unknown individual whom with no future connection is expected.

In today's image sharing environment, there is a need for an improved system and method that allows for image sharing from an Event/Experience regardless of association or connection between its Attendees and/or Host. Additionally, there is a need to have this ability without temporal or geographic limitations.

### SUMMARY OF THE INVENTION

The present invention is a system and method for the anonymous sharing of digital photos, digital images, or videos (all defined herein as “Images”) between Attendees of the same Event/Experience by using a unique identifier code. This unique identifier code (herein defined as a “QR code”) may be available via a server-based application that may be accessed via the web or mobile application (both herein referred to as “APP”). This APP may be accessed by using a smart phone, tablet, computer, smartwatch, or other device that has scanning capability and internet connectivity.

The QR Code(s) may be requested by an Event Host/Organizer, generated by the APP, or third-party provider, and disseminated by the Host/Organizer to Attendees of an Event/Experience using myriad digital or physical methods. Attendees of the Event/Experience may scan the QR Code from any of these methods by using a smart phone, tablet, computer, smartwatch, or other device that has scanning capability and internet connectivity. The method of sharing Images described herein does not require any Attendee to identify themselves or to have any prior connection to any other Attendee. No names, email addresses, phone numbers, social media accounts, or other personal data is required to share images between Attendees. Additionally, the Event Host/Organizer may also remain anonymous to all Attendees. The QR Code is the common denominator that links the Host/Organizer to All Attendees, and All Attendees to one another. The QR Code serves as the key to allow for the anonymous exchange of Images between a multitude of participants of the same Event/Experience.

One example of the present invention may be exemplified by a common concert going experience where one Attendee is seated far from the stage and therefore unable to take quality images of the stage/band/musicians. Conversely, other Attendees of the same concert may have seats that are closer to the stage/band/musicians. In addition to an Attendee's location within a venue, other impediments to image equality may include differences in photographic equipment, one's overall photographic skill, and one's natural propensity to take digital photographs or videos.

With the system and method defined herein, Attendees of an Experience/Event with poor seats, inferior equipment, or inferior photographic acumen may search through uploaded images from other Attendees who may have taken better photos or videos of the Event/Experience. Using the system and method defined herein, all Attendees may then download all other Attendees' photos, images, or videos from the same Experience/Event. This may be done without any of the Attendees having any personal connection to, or knowledge of, any other Attendee. The Event Host/Organizer may also be included in the image sharing pool.

### BRIEF DESCRIPTION OF THE DRAWINGS/FIGURES

The accompanying figures incorporated in, and forming a part of, these specifications illustrate several aspects of the invention. Together with the description, these figures serve to explain the principles of the invention.

FIG. 1 conceptually illustrates the process by which a Host/Organizer becomes a registered user, or by which a Host/Organizer accesses the APP as a registered user.

FIG. 2A conceptually illustrates the process by which a Host/Organizer uses the APP to generate a unique QR code, or a multitude of QR Codes. It also notes the creation of an image gallery associated with that unique QR Code. At any time during the QR Code creation process, the Host/Organizer also has the ability to set anonymity preferences.

FIG. 2B conceptually illustrates the process by which a Host/Organizer uses the APP to request and receive a unique QR code, or a multitude of QR Codes, from a third-party QR Code provider. It also notes the creation of an image gallery associated with that unique QR Code. At any time during the QR Code creation/retrieval process, the Host/Organizer also has the ability to set anonymity preferences.

FIG. 3 illustrates a sample of the methods by which unique QR Code(s) requested by the Host/Organizer, and generated via the APP, or a third-party QR code provider, can be disseminated to Attendees of an Event/Experience.

FIG. 4 illustrates how Attendees may scan a unique QR Code provided on one of the example methods of dissemination. The number of Attendees shown is 17, however, there is no limit for the number of Attendees. As depicted, there is no direct connection between Attendees required. Additionally, no account, email address, phone number, or other data is required for Attendees to share images via the APP.

FIG. 5 illustrates the Image Gallery that Attendees (and Host) will have access to once the QR Code has been scanned.

FIG. 6 illustrates Attendees taking digital photographs/videos/images of an Event/Experience.

FIG. 7 illustrates Attendees uploading digital photographs/videos/images taken during the Event/Experience to the Image Gallery via the APP.

FIG. 8 conceptually illustrates the Image Gallery where Attendees and Host/Organizer may peruse all images/videos related to the Event/Experience that have been taken and uploaded.

FIG. 9 illustrates Attendees and Host/Organizer downloading images taken by other Attendees of the Event/Experience. Examples of a Shared Experience may include, but is not limited to, a wedding, concert, sporting event, recital, theatre, holiday, cruise vacation, party and virtual groups.

FIG. 10 illustrates a process wherein a 1^{st} Attendee scans the QR code from one of the example methods of dissemination, and subsequent Attendees scan the QR code from the 1^{st} Attendee or subsequent Attendees. There is no limit on the number of Attendees that may scan and/or share the QR code, although setting such limits may be a feature of the APP.

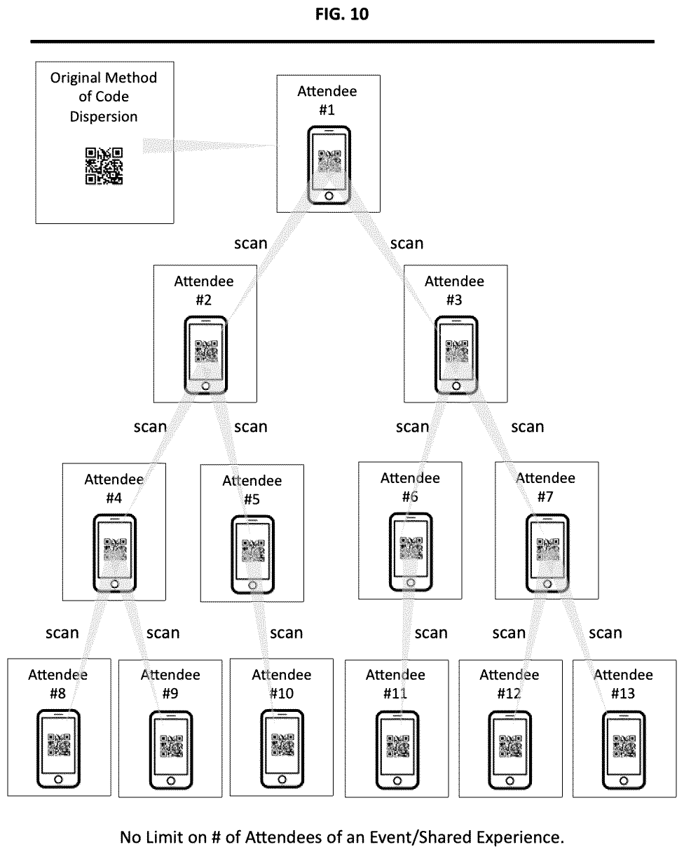

FIG. 11 illustrates a process wherein the 1^{st} Attendee obtains the QR code from one of the example methods of dissemination, and subsequent Attendees obtain the QR code from the 1^{st} Attendee, or subsequent Attendees, via Bluetooth or Near-filed Communication (BT/NFC). There is no limit on the number of Attendees that may scan and/or share the QR code, although setting such limits may be a feature of the APP.

### DETAILED DESCRIPTION

The embodiments set forth below represent the necessary information to enable those skilled in the art to practice the invention. While several embodiments are described herein, modifications, adaptations and other implementations are possible. Other embodiments may use different sequencing, an expanded or reduced number of steps, or different terminology to accomplish similar functions and/or features. In some embodiments, various operations may be performed in parallel, either in a synchronous or asynchronous manner. Upon reading the following description, and examining the accompanying figures, those skilled in the art will understand the concepts of the invention and will recognize the application of these concepts not specifically addressed herein.

The present invention provides a system and method for Attendees of the same Event/Experience to anonymously share images from that Event/Experience. This anonymous sharing of images is accomplished via the generation of a unique identifier code, or a multitude of unique identifier codes, requested by a Host/Organizer of an Event/Experience(s), and the creation of an Image Gallery associated with that specific unique identifier code Any unique identifier code known in the art may be used by the APP. In one embodiment, the unique identifier code uses a barcode symbology. In one embodiment, the QR code is a preferred unique identifier code and is used as an example of the unique identifier code herein throughout. Other unique identifier codes include, but are not limited to, a barcode or other optical machine-readable representation of data that may be disseminated through electronic or physical means. For example, a QR code or barcode may be printed or digitally produce and scanned by a reader including, but not limited to, a smart device, an optical barcode reader or wireless near-field communication, such as radio frequency identification (RFID) for example.

A unique identifier code, such as a QR code, may be disseminated to and among Attendees using physical or digital media. For example, a QR code may be distributed via email, text and/or internet browser. QR codes may be distributed on physical media, which include, but are not limited to, paper, posters, clothing, cards, billboards and the like.

The Host/Organizer may request a unique QR Code for a specific Event/Experience, or a multitude of QR Codes for a multitude of Events/Experiences. Once the APP, or third-party QR Code provider, generates the requested QR Codes, the Host/Organizer of the Event/Experience may then disseminate that QR Code to Attendees of the Event/Experience. Attendees may then scan the QR Code for that Event/Experience. Once Attendees have scanned the QR Code, they may access the Image Gallery, where they may upload their images, as well as peruse or download any other images posted by any other Attendee of the same Event/Experience In a preferred embodiment, the Attendees may use the scan, share, and other features of the APP while remaining anonymous to one another.

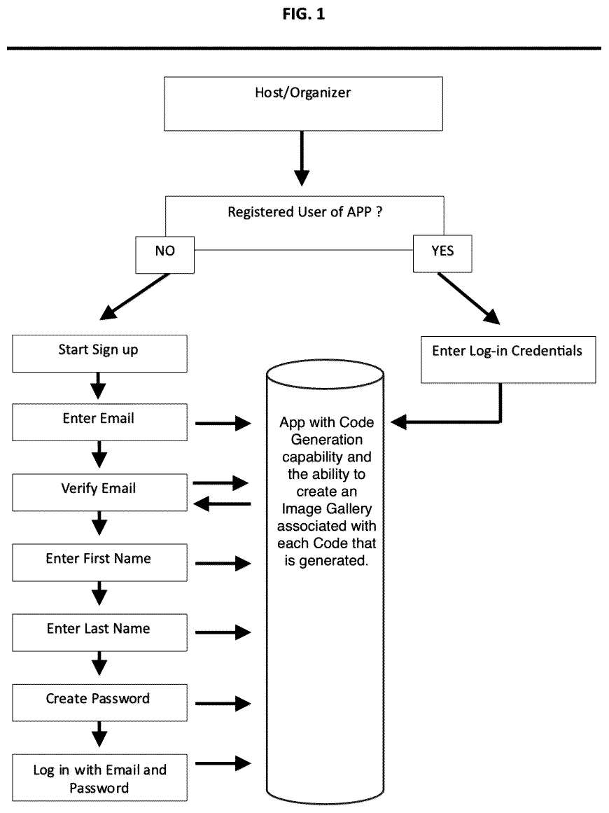

User Registration and Log In required by the APP according to one embodiment of the present invention is illustrated in FIG. 1. A Host/Organizer who is a Registered User in possession of valid, active log in credentials, may access the APP by providing their log in credentials. A Host/Organizer, who is not a Registered User, may register by providing their email, verifying that email, providing a First Name, providing a Last Name, creating a Password, and verifying that Password. Other registration and verification processes may be valid substitutions. Once the Host/Organizer is registered with the APP, they may log in to the APP using their log in credentials. Once the Host/Organizer has accessed the APP, the Host/Organizer may request a unique QR Code for an Event/Experience (or a multitude of QR Codes for a multitude of events/experience) It is important to remain cognizant of the fact that while the Host/Organizer may be required to divulge personal information to create an account and subsequent QR Code(s), Attendees are not required to register for an account, nor are they required to provide any information in order to access and utilize the image gallery for the Event/Experience It is equally important to remain cognizant of the fact that the Host/Organizer is not required to divulge any personal information to any of the Attendees.

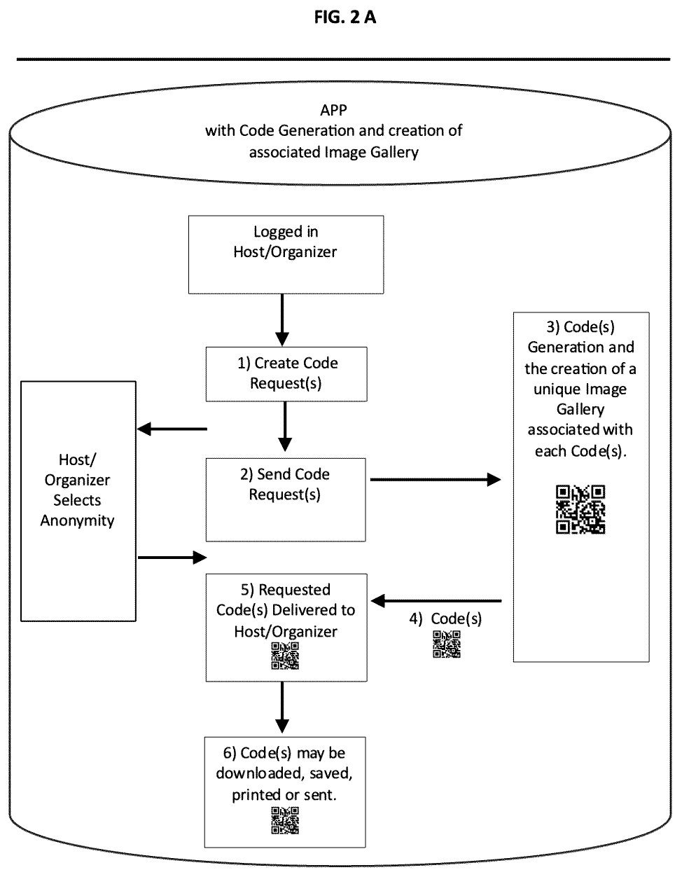

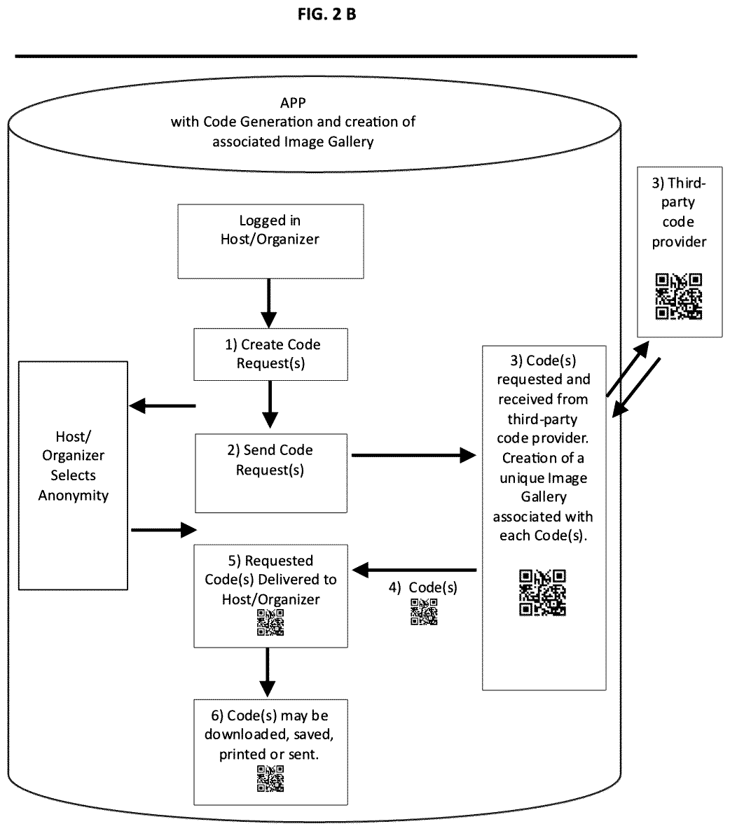

The request for a Unique QR Code according to one embodiment is illustrated in FIG. 2A where a registered Host/Organizer has logged in to the APP. After logging in, the Host/Organizer may generate a request, or a multitude of requests, for a unique QR Code(s). This QR Code request may require additional inputs such as a name for the Event/Experience. The QR Code request is then processed by the APP, which generates a QR Code, and sends it back to the Host/Organizer. During the code request and code generation process, the APP also creates an associated URL with image gallery for that specific QR Code. After the APP has transmitted the QR Code(s) to the Host/Organizer, the Host/Organizer may download, print, or save the QR Code(s).

The request for a Unique QR Code according to another embodiment is illustrated in FIG. 2B where a registered Host/Organizer has logged in to the APP and the APP requests a QR Code from third-party QR Code provider. After logging in, the Host/Organizer may generate a request, or a multitude of requests, for a unique QR Code(s) This QR Code request may require additional inputs such as a name for the Event/Experience. The QR Code request is then processed by the APP, which then obtains a QR Code from a third-party QR Code provider, and sends it to the Host/Organizer During the code request and code generation process, the APP also creates a URL with an associated image gallery for that specific QR Code. After the APP has transmitted the QR Code(s) to the Host/Organizer, the Host/Organizer may download, print, or save the QR Code(s).

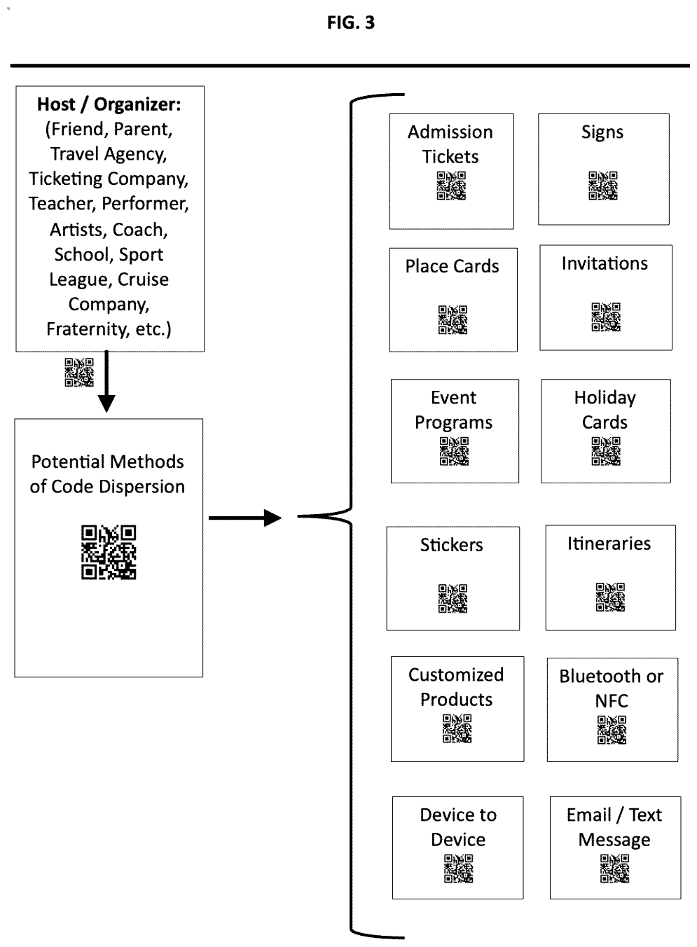

FIG. 3 illustrates various electronic and physical methods a Host/Organizer may use to disseminate the unique QR Code(s) created in FIG. 2A or FIG. 2B to Attendees of the Event/Experience.

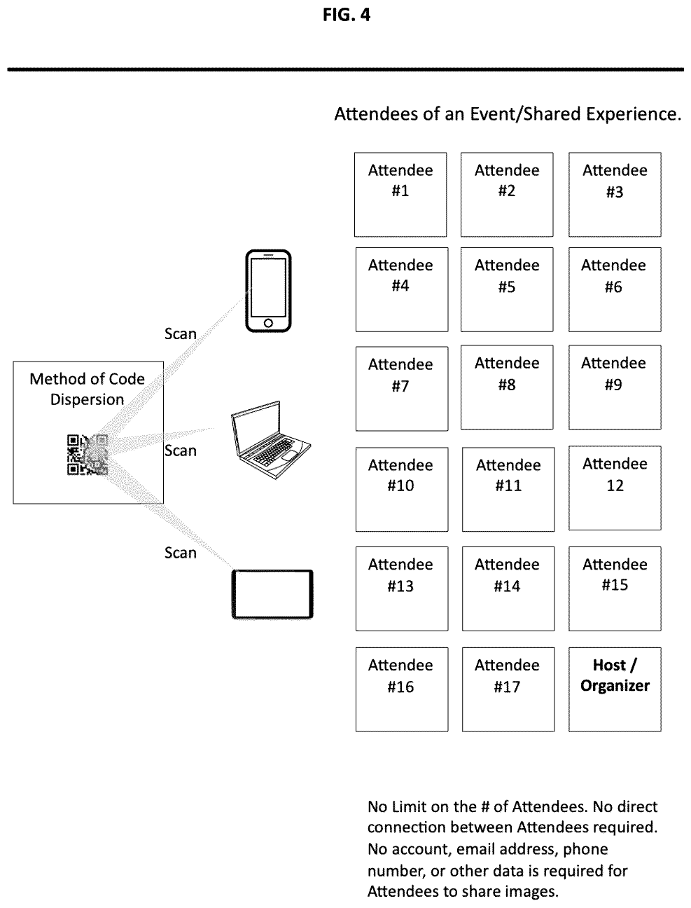

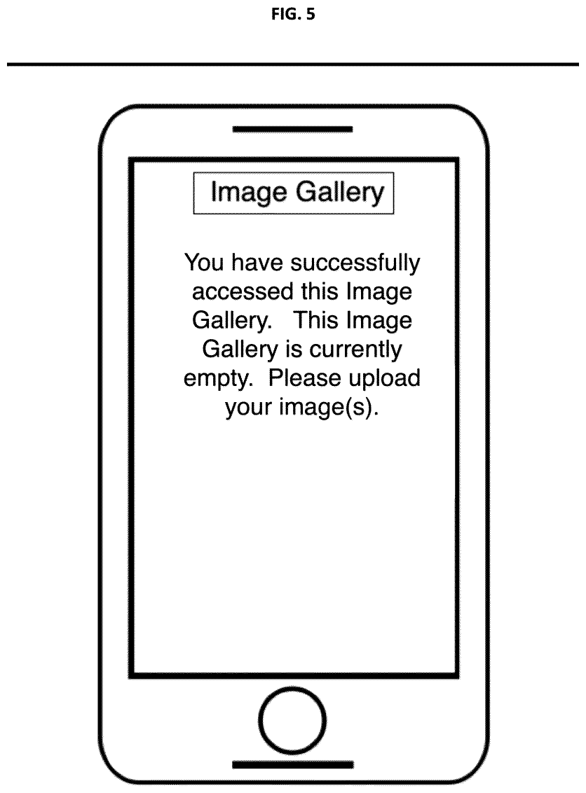

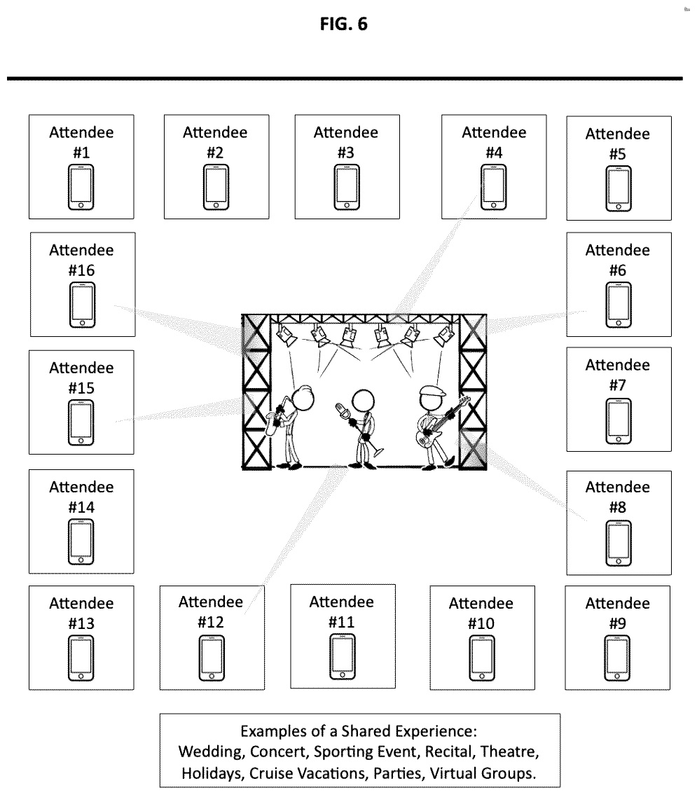

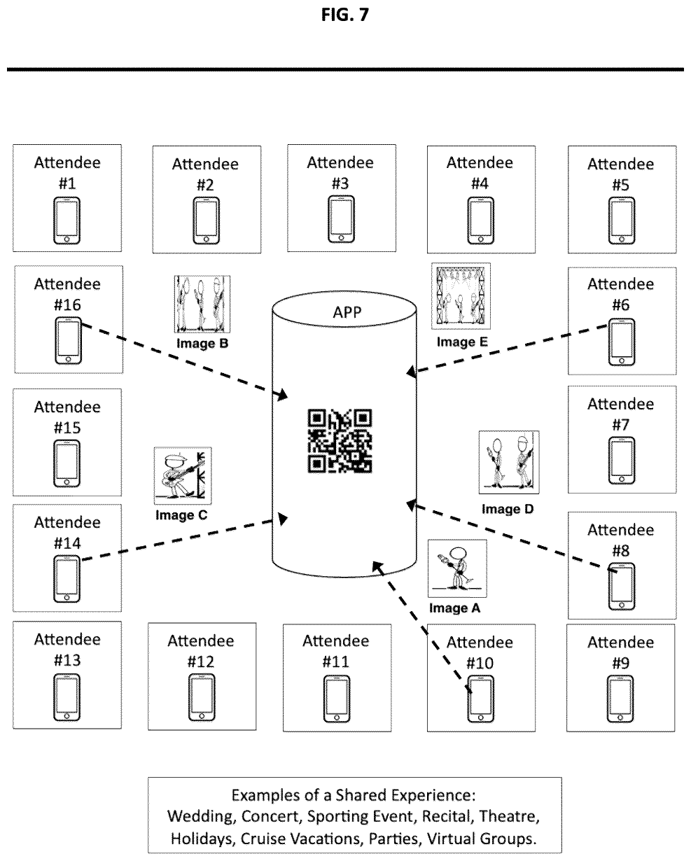

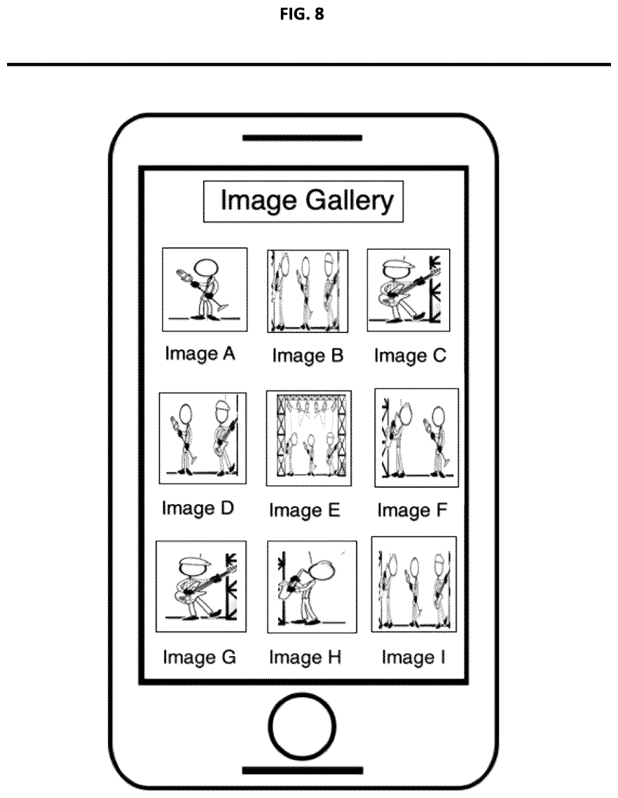

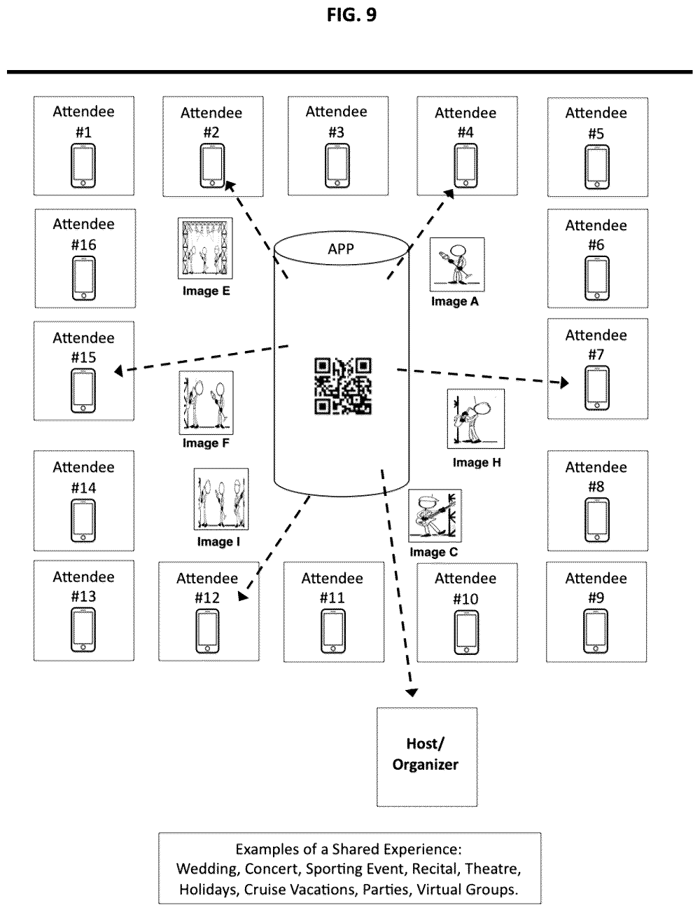

In an embodiment, the Host/Organizer arranges to have the QR Code generated/received by the APP to be printed onto an Admission Ticket (FIG. 3) for an Event/Experience. Any Attendee of the Event/Experience who wishes to do so, may scan the QR Code on the Admission Ticket (FIG. 4). By scanning the QR Code, Attendees may then access the image gallery for that Event/Experience (FIG. 5). With access to the image gallery, Attendees are able to upload (FIG. 7) any images they may have taken during the Event/Experience (FIG. 6). With access to an image gallery populated with images from the Event/Experience (FIG. 8), Attendees may also peruse and download (FIG. 9) any images taken by other Attendees who have uploaded images. The Host/Organizer may also have access to the image gallery. A common application of this embodiment may be a concert, county fair, performance, or sporting event that utilizes an Admission Ticket.

In another embodiment, the Host/Organizer arranges to have the QR Code generated/received by the APP to be printed onto Signage (FIG. 3) for an Event/Experience. Any Attendee of the Event/Experience who wishes to do so, may scan the QR Code on the Signage (FIG. 4). By scanning the QR Code, Attendees may then access the image gallery for that Event/Experience (FIG. 5). With access to the image gallery, Attendees are able to upload (FIG. 7) any images they may have taken during the Event/Experience (FIG. 6). With access to an image gallery populated with images from the Event/Experience (FIG. 8), Attendees may also peruse and download (FIG. 9) any images taken by other Attendees who have uploaded images. The Host/Organizer may also have access to the image gallery. A common application of this embodiment may be a banner, poster, or sign located near the entrance to an event venue, or within an event venue, that is hosting an art show, recital, theatre production, birthday, wedding, graduation, etc.

In another embodiment, the Host/Organizer arranges to have the QR Code generated/received by the APP to be printed onto Place Cards (FIG. 3), which may be located on tabletops at an Event/Experience. Any Attendee of the Event/Experience who wishes to do so, may scan the QR Code on the Place Card (FIG. 4). By scanning the QR Code, Attendees may then access the image gallery for that Event/Experience (FIG. 5). With access to the image gallery, Attendees are able to upload (FIG. 7) any images they may have taken during the Event/Experience (FIG. 6). With access to an image gallery populated with images from the Event/Experience (FIG. 8), Attendees may also peruse and download (FIG. 9) any images taken by other Attendees who have uploaded images. The Host/Organizer may also have access to the image gallery. A common application of this embodiment may be a wedding reception, a corporate dinner, or an awards ceremony.

In another embodiment, the Host/Organizer arranges to have the QR Code generated/received by the APP to be printed onto a physical Invitation (FIG. 3) or attached to an electronic Invitation for an Event/Experience. Any Attendee of the Event/Experience who wishes to do so, may scan the QR Code on the Invitation (FIG. 4). By scanning the QR Code, Attendees may then access the image gallery for that Event/Experience (FIG. 5). With access to the image gallery, Attendees are able to upload (FIG. 7) any images they may have taken during the Event/Experience (FIG. 6). With access to an image gallery populated with images from the Event/Experience (FIG. 8), Attendees may also peruse and download (FIG. 9) any images taken by other Attendees who have uploaded images. The Host/Organizer may also have access to the image gallery. A common application of this embodiment may be to any Event/Experience where an invitation is appropriate.

In another embodiment, the Host/Organizer arranges to have the QR Code generated/received by the APP to be printed onto an Event Program (FIG. 3) for an Event/Experience. Any Attendee of the Event/Experience who wishes to do so, may scan the QR Code on the Event Program (FIG. 4). By scanning the QR Code, Attendees may then access the image gallery for that Event/Experience (FIG. 5). With access to the image gallery, Attendees are able to upload (FIG. 7) any images they may have taken during the Event/Experience (FIG. 6). With access to an image gallery populated with images from the Event/Experience (FIG. 8), Attendees may also peruse and download (FIG. 9) any images taken by other Attendees who have uploaded images. The Host/Organizer may also have access to the image gallery. A common application of this embodiment may be a presentation of performing arts or a sporting event.

In another embodiment, the Host/Organizer arranges to have the QR Code generated/received by the APP be printed onto a Holiday Cards (FIG. 3), or attached to an Electronic Holiday Card. Any Attendee of the Event/Experience, whether remote or in-person, who wishes to do so, may scan the QR Code provided on the Holiday Card (FIG. 4). By scanning the QR Code, Attendees may then access the image gallery for that Event/Experience (FIG. 5). With access to the image gallery, Attendees are able to upload (FIG. 7) any images they may have taken during the Event/Experience (FIG. 6). With access to an image gallery populated with images from the Event/Experience (FIG. 8), Attendees may also peruse and download (FIG. 9) any images taken by other Attendees who have uploaded images. The Host/Organizer may also have access to the image gallery. An application of this embodiment would be a Host/Organizer who sends Holiday Cards for an event in the future, where potentially geographically dispersed Attendees can easily access and share images of a remotely shared Event/Experience.

In another embodiment, the Host/Organizer arranges to have the QR Code generated/received by the APP to be printed onto a Sticker (FIG. 3), which is then disseminated to Attendees of an Event/Experience that may be in-person or virtual. Any Attendee of the Event/Experience who wishes to do so, may scan the QR Code on the Sticker (FIG. 4). By scanning the QR Code, Attendees may then access the image gallery for that Event/Experience (FIG. 5). With access to the image gallery, Attendees are able to upload (FIG. 7) any images they may have taken during the Event/Experience (FIG. 6). With access to an image gallery populated with images from the Event/Experience (FIG. 8), Attendees may also peruse and download (FIG. 9) any images taken by other Attendees who have uploaded images. The Host/Organizer may also have access to the image gallery. The application of this embodiment may allow a Host/Organizer to turn any item into an image sharing gallery via a sticker with a unique QR Code.

In another embodiment, the Host/Organizer arranges to have the QR Code generated/received by the APP to be printed onto an Itinerary (FIG. 3) for a travel-related Event/Experience. Any Attendee of the travel-related Event/Experience who wishes to do so, may scan the QR Code on the Itinerary (FIG. 4). By scanning the QR Code, Attendees may then access the image gallery for that Event/Experience (FIG. 5). With access to the image gallery, Attendees are able to upload (FIG. 7) any images they may have taken during the Event/Experience (FIG. 6). With access to an image gallery populated with images from the Event/Experience (FIG. 8), Attendees may also peruse and download (FIG. 9) any images taken by other Attendees who have uploaded images. The Host/Organizer may also have access to the image gallery. A common application of this embodiment may be a Cruise Company, Airline, or Tour Agency where passengers may all scan the same QR Code from an Itinerary and share images from the travel-related Event/Experience.

In another embodiment, the Host/Organizer arranges to have the QR Code generated/received by the APP be printed onto a Customized Product (FIG. 3) for an Event/Experience. Any Attendee of the Event/Experience who wishes to do so, may scan the QR Code on the physical Customized Product (FIG. 4). By scanning the QR Code, Attendees may then access the image gallery for that Event/Experience (FIG. 5). With access to the image gallery, Attendees are able to upload (FIG. 7) any images they may have taken during the Event/Experience (FIG. 6). With access to an image gallery populated with images from the Event/Experience (FIG. 8), Attendees may also peruse and download (FIG. 9) any images taken by other Attendees who have uploaded images. The Host/Organizer may also have access to the image gallery. A common application of this embodiment may be a corporate event where company-sponsored products, such as coffee mugs, t-shirts, and baseball caps, are created with an incorporated QR Code and distributed to Attendees. The QR Code may then serve as the mechanism for image sharing.

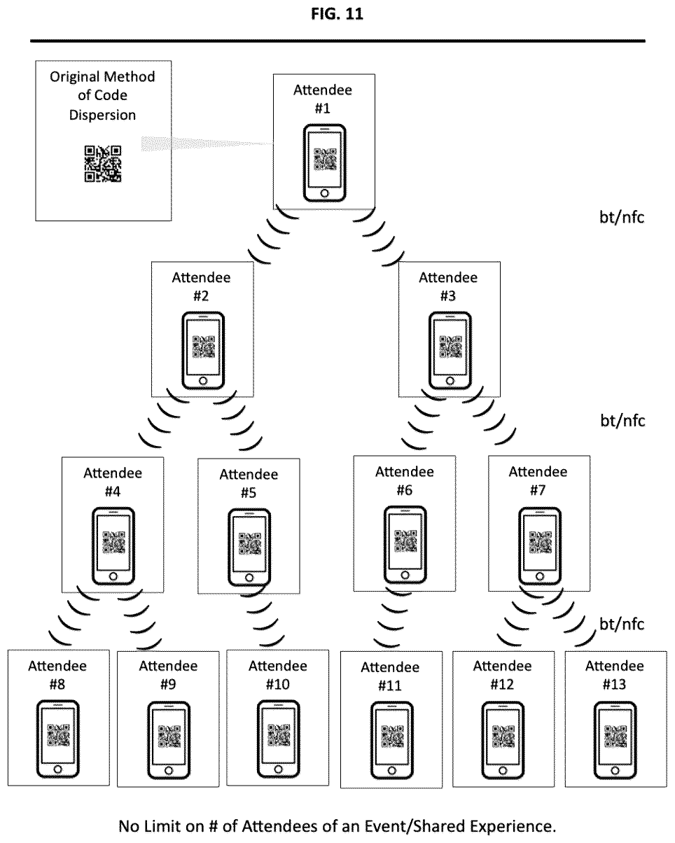

In another embodiment, the Host/Organizer arranges to have the QR Code generated/received by the APP to be shared via Bluetooth or Near-field Communication. In this embodiment, the original QR Code may be shared via any of the means depicted in FIG. 3. Once the first Attendee has scanned the QR Code and saved it to their smart device, that Attendee may then share that code with any other Attendee(s) via Bluetooth or Near-field Communication (NFC) (FIG. 11). The Attendee may accomplish this by holding their smart device within the Bluetooth or NFC range of another Attendee's smart device. In turn, that second Attendee may then share the QR Code via the same means with a third Attendee. The third Attendee may then share the QR Code via the same means to a fourth Attendee. Repeating this method of sharing the QR Code for an Event/Experience may allow all Attendees of an Event/Experience to scan the QR code for that Event/Experience. By receiving and scanning the QR Code, Attendees may then access the image gallery for that Event/Experience (FIG. 5). With access to the image gallery, Attendees are able to upload (FIG. 7) any images they may have taken during the Event/Experience (FIG. 6). Attendees may also peruse (FIG. 8) and download (FIG. 9) any images taken by other Attendees who have uploaded images. The Host/Organizer may also have access to the image gallery.

In another embodiment, the Host/Organizer arranges to have the QR Code generated/received by the APP to be shared directly from Smart Device to Smart Device. In this embodiment, the original QR Code may be shared via any of the means depicted in FIG. 3. Once the first Attendee has scanned the QR Code and saved it to their smart device, that Attendee may then share that code with any other Attendee(s) by allowing the second Attendee(s) to scan the QR Code that the first Attendee has saved to their smart device. The Attendee may accomplish this by presenting their smart device screen to a second Attendee. In turn, that second Attendee may then share the QR Code via the same means with a third Attendee. The third Attendee may then share the QR Code via the same means to a fourth Attendee. Repeating this method of sharing the QR Code for an Event/Experience may allow all Attendees of an Event/Experience to scan the QR code for that Event/Experience. By receiving and scanning the QR Code, Attendees may then access the image gallery for that Event/Experience (FIG. 5). With access to the image gallery, Attendees are able to upload (FIG. 7) any images they may have taken during the Event/Experience (FIG. 6). Attendees may also peruse (FIG. 8) and download (FIG. 9) any images taken by other Attendees who have uploaded images. The Host/Organizer may also have access to the image gallery.

In another embodiment, the Host/Organizer arranges to have the QR Code generated/received by the APP be disseminated to Attendees of an Event/Experience via Email/Text Message In this embodiment, the Host/Organizer is required to have the requisite contact information for the Attendee(s) of the Event/Experience. The Attendee(s), however, are not required to share any information with other Attendee(s). Attendee(s) of the Event/Experience who wish to do so, may scan the QR Code received via Email/Text Message and disseminated via any of the means depicted in FIG. 3. By scanning the QR Code, the Attendee may access the image gallery for that Event/Experience With access to the image gallery, the Attendee is able to upload (FIG. 6) any images they may have taken during the Event/Experience (FIG. 5). With access to the image gallery (FIG. 7), Attendees may also peruse (FIG. 7) and download (FIG. 8) any images taken by other Attendees who have uploaded images. The Host/Organizer may also have access to the image gallery.

In one embodiment of the invention, there is provided a system for generating an image gallery for an event or experience, the system comprising: a digital image library server configured to generate/process a QR code defining a unique event or experience, said server configured to generate a digital image library to store digital content files associated with the unique event or experience, plurality of mobile devices capable of reading the QR code, wherein the server automatically associates the one or more mobile devices with the unique event or experience based on the QR code data, wherein the server is configured to receive digital image files from the plurality of mobile devices for storage within a digital image library; wherein the users of a plurality of mobile devices remain anonymous to each other. In another embodiment, the system further provides that the server is configured to permit access to the digital image files received by the server from the plurality of mobile devices for the unique event or experience to each user of the plurality of mobile devices. In another embodiment, the system further provides that each user of the plurality of mobile devices are able to upload, peruse, and download images from the unique event or experience while remaining anonymous to all other users.

In another embodiment of the present invention, a computer-implemented method of using a machine-readable, unique identifier code to create an image gallery for an event or experience based upon that unique identifier code is provided. The method comprises generating the unique identifier code containing data to identify a unique event or experience defined by a host user, generating, by a processor, a digital media gallery associated with the unique event or experience to store digital content on a server, receiving, by a processor, an input from one of more users comprising data from the unique identifier, said input associating the one or more users to the unique event or experience, receiving, by a processor, an input from one of more users comprising digital content files from one or more users, and storing the digital content files in the digital media gallery associated with the unique event or experience, wherein the one or more users remain anonymous to each other. In another embodiment, the machine-readable, unique identifier code is a QR code.

In another embodiment, a method is provided for using a QR Code to create an image gallery for an event/experience based upon that QR Code, wherein access to the image gallery is anonymous and attendees of the event/experience are able to upload, peruse, and download images from that event/experience while remaining anonymous to all other Attendees.

In another embodiment, a method is provided for an App to generate a unique QR Code and create an anonymous image gallery for an event/experience wherein: a host/organizer of an event/experience requests a QR Code via an Application; a host/organizer receives the QR Code from the Application; a host/organizer provides that QR Code to Attendees of an event/experience; attendees of the event/experience scan the QR Code provided by the Host/Organizer; attendees of the event/experience are permitted access the anonymous Image Gallery for that event/experience; attendees of the event/experience are able to upload, peruse, and download images from that event/experience while remaining anonymous to all other attendees of the event/experience.

In another embodiment, a method is provided for an App to request a unique QR Code from a third-party QR Code provider, and create an anonymous image gallery for an event/experience wherein: a host/organizer of an event/experience requests a QR Code via an Application; a host/organizer receives the QR Code from the Application; a host/organizer provides that QR Code to Attendees of an event/experience; attendees of the event/experience scan the QR Code provided by the Host/Organizer; attendees of the event/experience are permitted access the anonymous Image Gallery for that event/experience; attendees of the event/experience are able to upload, peruse, and download images from that event/experience while remaining anonymous to all other attendees of the event/experience.

In another embodiment, a method is provided for anonymous image sharing between attendees of an event/experience comprising: a server-based application that generates unique QR Codes wherein each QR Code comprises data representing an image gallery within the application; a smart device, or a multitude of smart devices, with scanning capability and internet connectivity; accessing an event/experience image gallery by scanning of the application-generated QR Code; allowing anonymous attendees of the event/experience with image gallery access the ability to anonymously upload, peruse, and download images from the image gallery associated with the QR Code and its associated event/experience. In another embodiment, a method is provided for anonymously image sharing between attendees of an event/experience wherein participating attendees are not required to reveal any personal information. In another embodiment, a method of the current invention further provides receiving, over a network, a plurality of images from the plurality of mobile devices; and storing the plurality of images from the plurality of mobile devices.

In another embodiment, a method is provided for disseminating a unique QR Code for an event/experience on physical media. The physical media may be selected from a group consisting of: Admission Ticket, Signage, Place Cards, Invitations, Event Programs, Holiday/Greeting Cards, Stickers, Itineraries, or Customized Products.

In one embodiment, there is provided a computer-implemented method of using a QR Code to create an image gallery for an event or experience, wherein the Users of the image gallery remain anonymous to all other Users of the image gallery. A QR code is created and serves as a link that direct users to an image-sharing system comprising an image repository or gallery associated with an event or experience. The QR code is distributed to the public as an invitation to join the image-sharing system. In one embodiment, the QR code is distributed to invitees of the event. In another embodiment, the QR code is widely distributed to people as part of a marketing campaign or otherwise to people whose interest may align to the event or experience. Individual invitees may scan the QR code using their personal mobile or computing devices and are directed to the image-sharing system. The invitees may or may not be asked for log-in credentials to gain access to the image-sharing system. Using the data contained in the QR code, the invitees are automatically directed to the image gallery created for their event or experience within the image-sharing system. The image gallery is populated with images uploaded by the host and/or other invitees. Invitees to the event or experience may view, download, and/or upload images to the image gallery without sharing personal identifying information.

### Example 1

A signed-in, registered User of an APP requests a QR Code from the APP by filling out a form (either web-based or via native smartphone app).

A unique URL for an Image Gallery is created, and an associated unique QR Code is generated for that unique URL.

The server stores the URL and QR Code for the Image Gallery so that any user may access the same image repository based on the unique QR Code.

The App sends the requested QR Code to the User.

The User disseminates the QR Code via external physical materials (e.g. placards) or digital media (e.g. 3rd party websites or email).

The QR Code is scanned by an event/experience Attendee with a smart device that has a camera and internet connectivity.

The camera on a user's Smart Device processes the QR code via image software and allows the user to redirect their browser to the URL encoded in the QR Code.

The App accepts images for upload to the image repository by a User who has scanned the QR Code.

The App allows for perusal and download of uploaded images from the image repository from Users who have scanned the QR Code.

What is claimed is:

1. A computer-implemented method of using a QR Code to create an image gallery for an event or experience, wherein the Users of the image gallery remain anonymous to all other Users of the image gallery.

2. A computer-implemented method of using a machine-readable, unique identifier code, and associated unique URL, to create an image gallery for an event or experience based upon that unique identifier code, the method comprising
generating the unique identifier code, and associated URL, containing data to identify a unique event or experience, defined by a host user,
generating, by a processor, a digital media gallery associated with the unique event or experience to store digital content on a server,
receiving, by a processor, an input from one of more users comprising data from the unique identifier, said input associating the one or more users to the unique event or experience,
receiving, by a processor, an input from one of more users comprising digital content files from one or more users, and
storing the digital content files in the digital media gallery associated with the unique event or experience,
wherein the one or more users remain anonymous to each other.

3. A method of claim 2, wherein the machine-readable, unique identifier code is a QR code.

4. A method of using a QR Code, and associated URL, to create an image gallery for an event/experience based upon that QR Code, wherein access to the image gallery is anonymous and attendees of the event/experience are able to upload, peruse, and download images from that event/experience while remaining anonymous to all other Attendees.

5. A method of using an App to generate a unique QR Code, and associated URL, and create an anonymous image gallery for an event/experience wherein:
a host/organizer of an event/experience requests a QR Code via an Application;
a host/organizer receives the QR Code from the Application;
a host/organizer provides that QR Code to Attendees of an event/experience;
attendees of the event/experience scan the QR Code provided by the Host/Organizer;
attendees of the event/experience are permitted access the anonymous Image Gallery for that event/experience;
attendees of the event/experience are able to upload, peruse, and download images from that event/experience while remaining anonymous to all other attendees of the event/experience.

6. A method for anonymous image sharing between attendees of an event/experience comprising: a server-based application that generates, or receives from a third-party, a unique QR Codes wherein each QR Code comprises data representing a URL-based image gallery; a smart device, or a multitude of smart devices, with scanning capability and internet connectivity; accessing an event/experience image gallery by scanning of the generated/received QR Code; allowing anonymous attendees of the event/experience with image gallery access the ability to anonymously upload, peruse, and download images from the image gallery associated with the QR Code and its associated event/experience,

7. A method for anonymously image sharing between attendees of an event/experience wherein participating attendees are not required to reveal any personal information,

8. A physical method for disseminating a unique QR Code for an event/experience wherein said physical media is selected from a group consisting of: Admission Ticket, Signage, Place Cards, Invitations, Event Programs, Holiday/Greeting Cards, Stickers, Itineraries, or Customized Products.

9. The method of claim 1 further comprising receiving, over a network, the plurality of images from the plurality of mobile devices; and storing the plurality of images from the plurality of mobile devices.

10. A system for generating an image gallery for an event or experience, the system comprising:
a digital image library server configured to generate a unique URL address and associated QR code defining a unique event or experience,
said server configured to generate a digital image library to store digital content files associated with the unique event or experience,
plurality of mobile devices capable of reading the QR code, wherein the server automatically associates the one or more mobile devices with the unique event or experience based on the QR code data,
wherein the server is configured to receive digital image files from the plurality of mobile devices for storage within a digital image library;
wherein the users of a plurality of mobile devices remain anonymous to each other.

11. The system of claim 10, wherein each user of the plurality of mobile devices are able to upload, peruse, and download images from the unique event or experience while remaining anonymous to all other users.
